(19) United States
(12) Patent Application Publication
(10) Pub. No.: US 2006/0149732 A1
(43) Pub. Date: Jul. 6, 2006

(54) LIBRARY EXTRACTING DEVICE AND METHOD FOR AUTOMATICALLY EXTRACTING LIBRARIES OF AN EMBEDDED OPERATING SYSTEM

(76) Inventors: Jiun-Jeng Huang, Taipei City (TW); Ruey-Yuan Tzeng, Taipei City (TW)

Correspondence Address: NORTH AMERICA INTELLECTUAL PROPERTY CORPORATION, P.O. BOX 506, MERRIFIELD, VA, 22116, US

(21) Appl. No.: 11/161,432

(22) Filed: Aug. 3, 2005

(30) Foreign Application Priority Data
Jan. 5, 2005 (TW) 094100279

(51) Int. Cl. G06F 17/30

(52) U.S. Cl. 707/6

(57) ABSTRACT

A library extracting device and method for extracting libraries of an embedded operating system. The embedded operating system has a plurality of binary files and a plurality of libraries. The library extracting device includes a first checking module for generating a required library list according to libraries required by the binary files, a second checking module for generating an existing library list according to the libraries, a comparing module for comparing the required library list with the existing library list to detect a necessary library which is required by a binary file but not included in the libraries, and a extracting module for retrieving the necessary library from a predetermined library set and for adding the necessary library into the libraries.

### BACKGROUND OF THE INVENTION

1. Field of the Invention

The present invention relates to a library extracting device and method thereof, and more particularly, to a library extracting device and method thereof capable of automatically extracting libraries of an embedded operating system.

2. Description of the Prior Art

Embedded systems and their related application devices are increasingly popular. Many devices both in production and in development utilize embedded systems, such as: information appliances (IA), smart phones, and set-top boxes. Embedded systems are typically composed of computer software (e.g., an embedded operating system) and computer hardware (e.g., system single chip). The embedded system is developed based on a specific purpose. Because of this narrow development goal, the embedding system as compared with a typical personal computer, has advantages including: high stability, small footprint, and low cost. For the embedded system, many products such as Palm OS, Windows CE, or Linux are utilized. The Linux operating system is especially popular because it is available as open source software.

The development process of embedded systems is unlike many other development efforts. This is necessary because the products and tools that are utilized to develop embedded systems belong to many different operational environments. For example, software applications (i.e., programs) for personal computers are developed and later executed (i.e., run) on the same platform (e.g., perhaps the above-mentioned personal computer). Embedded systems development is very different. The embedded systems developer must develop programs, for example, the embedded system's operating system (OS), by utilizing another platform such as a personal computer. Additionally, after the embedded system's programs are completely developed, the developer must generate an image file (i.e., binary image) corresponding to the programs. The image file must be burned into a nonvolatile storage device (e.g., a ROM, or a flash memory) of the target devices. Lastly, the target devices generate a binary file according to the above-mentioned image file and execute the binary file to check the function of the programs.

Typically, the embedded operating system is developed to provide the appropriate function according to the hardware of the embedded system. To reduce the embedded system's production cost, the embedded system will provide only the storage space that is required for the specified function. Therefore, when the embedded system is designed, the system developer is keenly aware of storage space concerns. As known by those skilled in the art, a library is a part of the binary file. Many binary files have components in common. If common components are located in the libraries then storage space can be saved by removing the redundant libraries. Therefore, unnecessary libraries may increase the cost and reduce the efficiency, but the embedded operating system cannot operate normally without enough libraries. Therefore, the system developer has to check the binary files inside the target devices one by one, listing all necessary libraries, and comparing the libraries stored in the target device with the necessary libraries to determine whether all necessary libraries are stored or whether redundant libraries may be removed. The above-mentioned operation is called a library extraction.

The library extraction mentioned above requires a lot of time and mistakes may occur easily during the process. The operation of the library extraction is illustrated as follows. First, the system developer manually checks the necessary libraries of each individually binary file of a root file system. The system developer manually establishes a list of required libraries. Secondly, the system developer will manually check the libraries that are stored in the root file system to establish a list of all the existing libraries. Thirdly, the system developer manually compares the two lists: the required libraries and the existing libraries. If the system developer finds a required library that is not on the existing library list then the system developer must manually copy those necessary libraries from a storage device, where the necessary libraries are stored, to a root file system. Alternatively, if the system developer finds that a redundant library of the existing library list is not listed in the required library list, the system developer manually removes the redundant library from the root file system. As mentioned above, in the prior art, all library extraction operations are all performed manually. As a result, the efficiency of this process is poor and mistakes are common.

### SUMMARY OF THE INVENTION

It is therefore one of primary objectives of the claimed invention to provide a library extracting device and method capable of automatically extracting libraries of an embedded operating system, to solve the above-mentioned problem.

According to an exemplary embodiment of the claimed invention, a library extracting method for extracting libraries of an embedded operating system is disclosed. The embedded operating system comprises a plurality of binary files and a plurality of libraries, and the library extracting method comprises: providing an automatic processing mechanism; and executing the automatic processing mechanism to generate a required library list according to libraries required by the binary files, to generate an existing library list, to compare the required library list with the existing library list to detect a necessary library which is required by a binary file but not in the libraries, to retrieve the necessary library from a predetermined library set, and to add the necessary library into the libraries.

In addition, a library extracting device for extracting libraries of an embedded operating system is disclosed. The embedded system comprises a plurality of binary files and a plurality of libraries and the library extracting device comprises: a first checking module for generating a required library list according to the binary files; a second checking module for generating an existing library list according to the libraries; a comparing module for comparing the required library list with the existing library list to detect a necessary library which is required by a binary file but not in the libraries; and an extracting module for retrieving the necessary library from a predetermined library set and adding the necessary library into the libraries.

The present invention library extracting device and method can utilize a library extracting hardware or software to automatically compare a required library list with an existing library list, to automatically retrieve necessary libraries required by a binary file, and to automatically delete unnecessary libraries. Therefore, the present invention library extracting device and method not only can raise the operational efficiency of extracting libraries, but also can reduce the possibility of making mistakes when libraries are extracted.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is a diagram of a library extracting device of an embodiment according to the present invention.

FIG. 2 is a flow chart of performing a library extraction of a library extracting device shown in FIG. 1.

FIG. 3 is a detailed flow chart of step 102 shown in FIG. 2.

### DETAILED DESCRIPTION

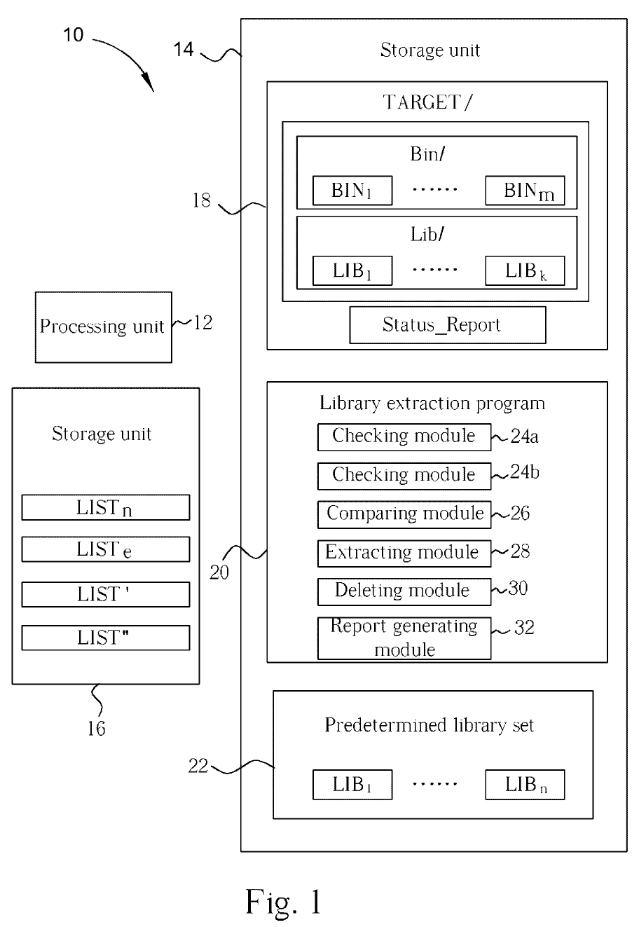

Please refer to FIG. 1, which is a library extracting device 10 of an embodiment according to the present invention. The library extracting device 10 comprises a processing unit 12 and a plurality of storage units 14 and 16. In this embodiment, the storage unit 14 is a nonvolatile storage device for storing a root file system of an embedded operating system, such as Linux, a library extraction program 20, and a predetermined library set 22, wherein the root file system 18 is designed according to a specific target device (i.e., the embedded system) and the predetermined library set 22 comprises a plurality of libraries LIB₁-LIBₙ utilized by the embedded operating system. As shown in FIG. 1, the root file system 18 is stored in a specific directory TARGET/ of the storage unit 14. The specific directory TARGET/ comprises a binary directory bin/ and a library directory lib/, wherein the binary directory bin/ stores a plurality of binary codes BIN₁-BINₘ and the library directory lib/ stores a plurality of libraries LIB₁-LIBₖ. Please note that the libraries LIB₁-LIBₖ are a subset of the libraries LIB₁-LIBₙ. Furthermore, the library extracting program 20 comprises a plurality of checking modules 24a and 24b, a comparing module 26, an extracting module 28, a deleting module 30, and a report generating module 32. In this embodiment, the storage unit 16 is a volatile storage unit for temporarily storing data generated by executing the library extracting program 20. For example, the processing unit 12 respectively executes the checking modules 24a and 24b to generate the required library list LISTₙ and the existing library list LISTₑ, The processing unit 12 also executes the comparing module 26 to compare the required library list LISTₙ with the existing library list LISTₑ. Please note that in this embodiment, when the library extracting device 10 completes one operation of library extraction, a status report STATUS_REPORT is stored in the specific directory TARGET/ of the storage unit 14.

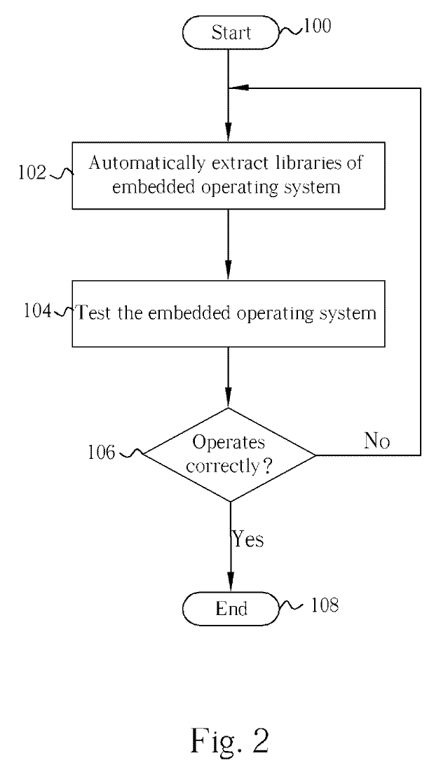

Please refer to FIG. 1 in conjunction with FIG. 2. FIG. 2 is a flow chart of performing the library extraction of a library extracting device 10 shown in FIG. 1.

Step 100: Start;

Step 102: The processing unit 12 executes the library extracting program 20 to automatically extract libraries of the root file system 18 of an embedded operating system;

Step 104: Perform a function test on the embedded operating system utilizing a target device;

Step 106: Can the embedded operating system operate correctly utilizing the embedded operating system? If it can, go to step 108; otherwise, go back to step 102:

Step 108: Finish.

After a system developer finishes developing the embedded operating system of a target device (i.e., the embedded system), the system developer can perform the automatic library extraction utilizing the present invention library extracting device 10 (step 100). In other words, the system developer utilizes the library extracting device 10 to execute the library extraction program 20 and assigns appropriate parameters to the library extraction program 20. For example, the system developer can input the directory information (the directory TARGET/) of the root file system 18 of the embedded operating system to store the binary directory information (the binary directory bin/) and the library directory information (the library information lib/) to the library extracting device 10. Therefore, the present invention library extraction program 20 can automatically perform the library extraction on the root file system 18 according to the above-mentioned parameters (step 102). After the library extracting device 10 finishes the step 102, the system developer can generate a corresponding image file according to the embedded operating system. The image file is then processed through the library extraction and stored in the storage unit 14. The system developer can further execute the embedded operating system through the target device to test its function (step 104). If the root file system 18 cannot be executed correctly utilizing the target device then a mistake may have occurred in step 102 when the library was extracted. If the root file system 18 cannot be executed then go back to the step 102 and perform the library extraction again. However, if the root file system 18 can be executed correctly, this means that the library extraction in the step 102 was performed correctly and therefore the whole flow of library extraction is completely finished (step 108).

Please note that in this embodiment, the library extracting device 10 is implemented by a prior art personal computer. Therefore, the processing unit 12 is a well-known central processing unit (CPU) 12, the storage unit 14 is a hard disk, and the storage unit 16 is a main memory. However, the above-mentioned library extracting device 10 is not limited to implementation on a personal computer, that is, the personal computer is only utilized for a preferred embodiment of the present invention. Furthermore, the storage unit 14 can be integrated with the computer network to provide operational flexibilities to the library extracting device. Therefore, the root file system 18, the library extraction program 20, and the predetermined library set 22 are not limited by the constraints of a single storage device or even the same storage device. For example, the storage unit 14 can comprises a plurality of network disks, and the root file system 18, the library extraction program 20, and the predetermined library set 22 are respectively stored in different network disks. Therefore, through the network, the processing unit of the library extracting unit can also smoothly access the root file system 18, the library extraction program 20, and the predetermined library set 22.

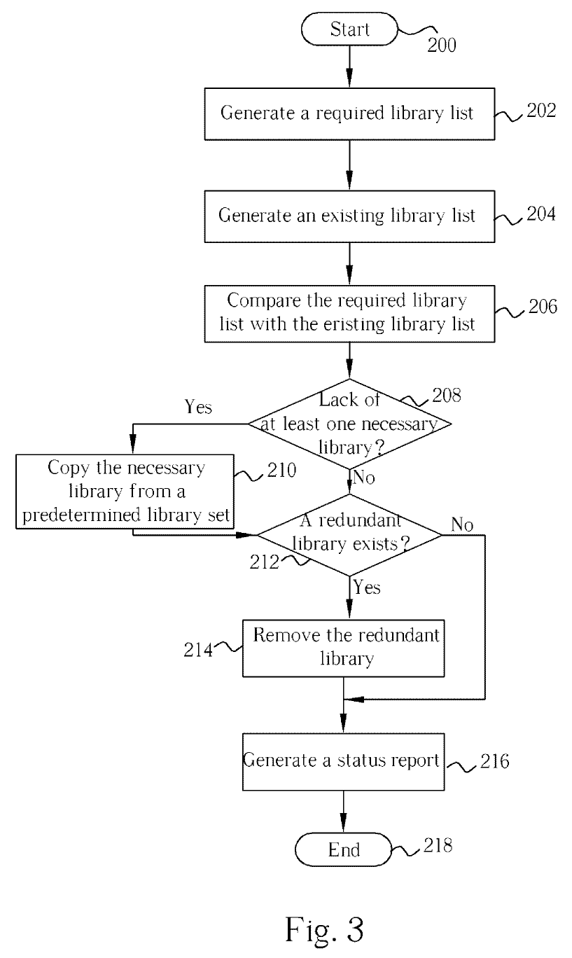

Please refer to FIG. 3 in conjunction with FIG. 1 and FIG. 2. FIG. 3 is a detailed flow chart of the step 102 shown in FIG. 2. The present invention automatic library extraction comprises the following steps.

Step 200: Start;

Step 202: The processing unit 12 executes the checking module 24a to read the binary codes BIN₁-BINₘ from the binary directory bin/ to generate a required library list LISTₙ;

Step 204: The processing unit 12 executes the checking module 24b to read the LIB₁-LIBₖ from the library directory lib/ to generate an existing library list LISTₑ;

Step 206: The comparing module 24 detects whether there is one necessary library which is listed in the required library list LISTₙ but not in the existing library list LISTₑ; if the comparing module 24 detects there is one necessary library which is listed in the required library list LISTₙ but not in the existing library list LISTₑ, go to step 210; otherwise, go to step 212;

Step 210: The processing unit 12 executes the extracting module 28 to read the necessary library from the predetermined library set 22 and copy the necessary library to the library directory lib/;

Step 212: The comparing module detects whether there is a redundant library which is listed in the existing library list LISTₑ but not in the required library list LISTₙ; if the comparing module detects there is one redundant library which is listed in the existing library list LISTₑ but not in the required library list LISTₙ, then go to step 214; otherwise go to step 216;

Step 214: The processing unit 12 executes the deleting module 30 to remove the redundant library from the library directory lib/.

Step 216: The processing unit 12 executes the report generating module 32 to generate a status report STATUS_REPORT of the library extraction; and

Step 218: Finish.

The present invention library extracting device 10 executes the library extraction program 20 to achieve the purpose of automatically extracting the libraries of the root file system 18. This operation is illustrated as follows. Assuming that the binary codes BIN₁-BINₘ need the libraries LIB₂-LIBₖ₋₁ and LIBₖ₊₁-LIBₖ₊₃, and the libraries LIBₖ₊₁-LIBₖ₊₃ is a subset of the libraries LIB₁-LIBₙ. Therefore, when the library extraction is performed (step 200), the checking module 24a can generate a required library list LISTₙ according to the binary codes BIN₁-BINₘ, wherein the required library list LISTₙ stores the library names of the libraries LIB₂-LIBₖ₋₁ and LIBₖ₊₁-LIBₖ₊₃ (step 202). Similarly, another checking module 24b generates an existing library list LISTₑ according to the libraries LIB₁-LIBₖ, wherein the existing library list LISTₑ stores the library names of the libraries LIB₁-LIBₖ (step 204). And then, the comparing module 26 compares the library names stored in the required library list LISTₙ with the library names stored in the existing library list LISTₑ (step 206). Because the required library list LISTₙ and the existing library list LISTₑ are not totally the same. Therefore, the comparing module 26 detects at least one library which is listed in the required library list LISTₙ (that is, the libraries LIBₖ₊₁˜LIBₖ₊₃) but not listed in the existing library list LISTₑ (step 208). In other words, the root file system 18 lacks of necessary libraries LIBₖ₊₁˜LIBₖ₊₃, therefore, the comparing module 26 generates a library requiring list LIST′, which comprises the library names of LIBₖ₊₁˜LIBₖ₊₃. And the extracting module 28 reads the libraries LIBₖ₊₁˜LIBₖ₊₃ from the predetermined library set 22 and copies the libraries LIBₖ₊₁˜LIBₖ₊₃ into the library directory lib/ (step 210). Furthermore, the comparing module 26 also detects the libraries LIB₁ and LIBₖ which are listed in the existing library list LISTₑ but not in the required library list LISTₙ (step 212). That is, the root file system 18 stores unnecessary LIB₁ and LIBₖ. Therefore, the comparing module 26 generates a redundant library list LIST″, which stores the library names of the library LIB₁ and LIBₖ. The deleting module 32 removes the redundant libraries LIB₁ and LIBₖ from the library directory lib/ according to the redundant library list LIST″. At last, the report-generating module 32 generates a status report STATUS_REPORT according to the result of the above-mentioned operation and store the status report STATUS_REPORT in a specific directory TARGET/ (step 216). Therefore, after storing the status report STATUS_REPORT, the whole library extraction is completely finished (step 218).

Please note that the order of step 202 and step 204 is only utilized for an illustration of the present invention, not a limitation. Actually, the present invention can perform the step 204 first, and then perform the step 202. Or, the present invention can simultaneously perform step 202 and step 204 after the step 200. Similarly, shown in FIG. 3, the order of step 208 and step 212 is only utilized for an illustration, not a limitation. Actually, the present invention can perform the step 212 first, and then the step 208. Or, the present invention can simultaneously perform step 208 and step 212 after the step 206. The above-mentioned changes all obey the spirit of the present invention. In addition, as mentioned above, the library extracting device 10 utilizes the processing unit 12 to execute the library extraction program (software) to automatically extract the libraries of the root file system 18. However, the present invention checking modules 24a and 24b, the comparing module 26, the extracting module 28, the deleting module 30, and the report generating module 32 can be implemented by hardware instead of the above-mentioned software. This also obeys the spirit of the present invention.

In contrast to the prior art, the present invention library extracting device and method can utilize a library extracting hardware/software to automatically compare a required library list with an existing library list, to automatically retrieve necessary libraries required by a binary file, and to automatically delete unnecessary library. Therefore, the present invention library extracting device and method not only can raise the operational efficiency of extracting libraries, but also can reduce possibilities of making mistakes when libraries are extracted.

Those skilled in the art will readily observe that numerous modifications and alterations of the device and method may be made while retaining the teachings of the invention. Accordingly, the above disclosure should be construed as limited only by the metes and bounds of the appended claims.

What is claimed is:

1. A library extracting method for extracting libraries of an embedded operating system, the embedded operating system comprising a plurality of binary files and a plurality of libraries, the library extracting method comprising:
providing an automatic processing mechanism; and
executing the automatic processing mechanism to generate a required library list according to libraries required by the binary files, to generate an existing library list, to compare the required library list with the existing library list to detect a necessary library which is required by a binary file but not in the libraries, to retrieve the necessary library from a predetermined library set, and to add the necessary library into the libraries.

2. The library extracting method of claim 1, wherein the step of executing the automatic processing mechanism further comprises:
comparing the required library list and the existing library list to detect a redundant library which is in the libraries but is not required by the binary files; and
removing the redundant library from the libraries.

3. A library extracting method for extracting libraries of an embedded operating system, the embedded system comprising a plurality of binary files and a plurality of libraries, the library extracting method comprising:
providing an automatic processing mechanism, and executing the automatic processing mechanism to generate a required library list according to the binary files;
generating an existing library list according to the libraries;
comparing with the required library list and the existing library list to detect a necessary library which is required by a binary file but not in the libraries; and
retrieving the necessary library from a predetermined library set and adding the necessary library into the libraries.

4. A library extracting method for extracting libraries of an embedded operating system, the embedded system comprising a plurality binary files and a plurality of libraries, the library extracting method comprising:
generating a required library list according to the binary files;
providing an automatic processing mechanism and executing the automatic mechanism to generate an existing library list according to the libraries;
comparing the required library list with the existing library list to detect a necessary library which is required by a binary file but not in the libraries; and
retrieving the necessary library from a predetermined library set and adding the necessary library into the libraries.

5. A library extracting method for extracting libraries of an embedded operating system, the embedded system comprising a plurality of binary files and a plurality of libraries, the library extracting method comprising:
generating a required library list according to the binary files;
generating an existing library list according to the libraries;
providing an automatic processing mechanism and executing the automatic processing mechanism to compare the required library list with the existing library list to detect a necessary library which is required by a binary file but not in the libraries; and
retrieving the necessary library from a predetermined library set and adding the necessary library into the libraries.

6. A library extracting method for extracting libraries of an embedded operating system, the embedded system comprising a plurality of binary files and a plurality of libraries, the library extracting method comprising:
generating a required library list according to the binary files;
generating an existing library list according to the libraries;
comparing the required library list with the existing library list to detect a necessary library which is required by a binary file but not in the libraries; and
providing an automatic processing mechanism and executing the automatic processing mechanism to retrieve the necessary library and add the necessary library into the libraries.

7. A library extracting device for extracting libraries of an embedded operating system, the embedded system comprising a plurality of binary files and a plurality of libraries, the library extracting device comprising:
a first checking module for generating a required library list according to the binary files;
a second checking module for generating an existing library list according to the libraries;
a comparing module for comparing the required library list with the existing library list to detect a necessary library which is required by a binary file but not in the libraries; and
an extracting module for retrieving the necessary library from a predetermined library set and adding the necessary library into the libraries.

8. The library extracting device of claim 7, wherein the comparing module further compares the required library list with the existing library list to detect a redundant library which is not required by the binary files but in the libraries, and the library extracting device further comprises a deleting module for removing the redundant library from the libraries.

9. The library extracting device of claim 7, wherein the first and the second checking modules, the comparing module, and the extracting module are all software, and the library extracting device further comprises:
a storage unit for storing the first and the second checking modules, the comparing module, and the extracting module; and
an processing unit coupled to the storing unit for executing the first and the second checking modules, the comparing module, and the extracting module.

10. The library extracting device of claim 9, wherein the processing unit is a central processing unit of a computer system.
